(19) United States
(12) Patent Application Publication
(10) Pub. No.: US 2026/0061850 A1
(43) Pub. Date: Mar. 5, 2026

(54) COMPUTER SYSTEM AND METHOD TO DISCHARGE A DC-LINK CAPACITOR

(71) Applicant: VOLVO TRUCK CORPORATION, Göteborg (SE)

(72) Inventors: Sebastian Hall, Göteborg (SE); Charlie Jägerhag, Göteborg (SE)

(73) Assignee: VOLVO TRUCK CORPORATION, Göteborg (SE)

(21) Appl. No.: 19/307,691

(22) Filed: Aug. 22, 2025

(30) Foreign Application Priority Data
Aug. 29, 2024 (EP) 24197228.0

(51) Int. Cl. B60L 3/00; B60L 15/02

(52) U.S. Cl. CPC B60L 3/0046; B60L 3/003; B60L 3/0061; B60L 15/025; B60L 2210/42; B60L 2240/421; B60L 2240/429

(57) ABSTRACT

A computer system has processing circuitry to obtain a discharge request of a DC-link capacitor of an electric drive system; disconnect an electrical machine of the electric drive system; determine a q current for the electrical machine being sufficient to start rotation of the electrical machine; and actively discharge the DC-link capacitor by applying the determined q current to the electrical machine.

### TECHNICAL FIELD

The disclosure relates generally to electrical systems. In particular aspects, the disclosure relates to computer systems and methods to discharge a DC-link capacitor. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Vehicles, in particular electric vehicles, are typically provided with a high-voltage system designed to provide the required electrical power to one or more electrical machines. When such electric vehicle stands still and is turned off the high-voltage system must be de-energized. Generally, this is achieved by discharging the stored energy from the DC-link capacitor of the converter that drives the electric machine through a dedicated resistor. However, since the DC-link energy discharge is very important out of a safety point of view, there is a need for backup solutions if the primary discharge procedure fails.

### SUMMARY

According to a first aspect of the disclosure, a computer system is provided. The computer system comprises processing circuitry configured to: obtain a discharge request of a DC-link capacitor of an electric drive system; disconnect an electrical machine of the electric drive system; determine a q current for the electrical machine being sufficient to start rotation of the electrical machine; and actively discharge the DC-link capacitor by applying the determined q current to the electrical machine. The first aspect of the disclosure may seek to provide a robust discharge of the DC-link capacitor using components normally already present in an electric drive system. A technical benefit may include using the electric machine as an energy dissipator to discharge the DC-link capacitor. Further, when rotating the machine, the current is distributed evenly between stator windings. Therefore, the risk of overheating or unnecessary wear of the components decreases.

Optionally in some examples, including in at least one preferred example, the processing circuitry is further configured to determine the q current for the electrical machine based on a reference rotational speed of the electrical machine. A technical benefit may include a robust yet efficient control of the electrical machine in order to achieve the desired discharge of the DC-link capacitor.

Optionally in some examples, including in at least one preferred example, the processing circuitry is further configured to set the reference rotational speed to a value being higher than the maximum rotational speed being achievable by the electrical energy stored by the DC-link capacitor. A technical benefit may include a fast discharge of the DC-link capacitor.

Optionally in some examples, including in at least one preferred example, the processing circuitry is further configured to set the reference rotational speed to a value being less than the maximum rotational speed being achievable by the electrical energy stored by the DC-link capacitor. A technical benefit may include a more controlled discharge of the DC-link capacitor.

Optionally in some examples, including in at least one preferred example, the processing circuitry is further configured to adjust the q current for the electrical machine such that the rotational speed of the electrical machine corresponds to the reference rotational speed. A technical benefit may include ensuring a constant speed of the electrical machine during discharging, thereby facilitating control by allowing the q current to be close to zero.

Optionally in some examples, including in at least one preferred example, the processing circuitry is further configured to determine a d current for the electrical machine being sufficient to discharge the DC-link capacitor to a safe level threshold; and discharge the DC-link capacitor by applying the determined d current to the electrical machine. A technical benefit may include controlling the discharge time by the d current, which represents the length of the current vector.

Optionally in some examples, including in at least one preferred example, the processing circuitry is further configured to short circuit the electrical machine when the voltage of the DC-link capacitor has reached the safe level threshold. A technical benefit may include reducing the risk for the electrical machine to energize the capacitor.

Optionally in some examples, including in at least one preferred example, the processing circuitry is further configured to disconnect an energy storage system of the electric drive system from the electrical machine; determine the q current for the electrical machine based on a reference rotational speed of the electrical machine; and set the reference rotational speed to a value being higher than the maximum rotational speed being achievable by the electrical energy stored by the DC-link capacitor, or set the reference rotational speed to a value being less than the maximum rotational speed being achievable by the electrical energy stored by the DC-link capacitor, and adjust the q current for the electrical machine such that the rotational speed of the electrical machine corresponds to the reference rotational speed. The processing circuitry is further configured to: determine a d current for the electrical machine being sufficient to discharge the DC-link capacitor to a safe level threshold; and discharge the DC-link capacitor by applying the determined d current to the electrical machine; wherein the processing circuitry is further configured to: short circuit the electrical machine when the voltage of the DC-link capacitor has reached the safe level threshold. A technical benefit may include a simple and easy-to-implement active discharging of the DC-link capacitor.

According to a second aspect of the disclosure, a vehicle is provided. The vehicle comprises the computer system of the first aspect. The second aspect of the disclosure may seek to may seek to provide a robust discharge of the DC-link capacitor using components normally already present in an electric drive system. A technical benefit may include using the electric machine as an energy dissipator to discharge the DC-link capacitor. Further, when rotating the machine, the current is distributed evenly between stator windings. Therefore, the risk of overheating or unnecessary wear of the components decreases.

Optionally in some examples, including in at least one preferred example, the vehicle further comprises an electric drive system, and a DC-link discharge system configured to passively discharge the DC-link capacitor. A technical benefit may include reducing the risk for errors in capacitor discharge, by having a primary passive discharge system and a secondary/backup active discharge system.

According to a third aspect of the disclosure, a computer-implemented method is provided. The computer-implemented method comprises: obtaining, by processing circuitry of a computer system, a discharge request of a DC-link capacitor of an electric drive system; disconnecting, by the processing circuitry, an electrical machine of the electric drive system; determining, by the processing circuitry, a q current for the electrical machine being sufficient to start rotation of the electrical machine; and actively discharging, by the processing circuitry, the DC-link capacitor by applying the determined q current to the electrical machine. The third aspect of the disclosure may seek to may seek to provide a robust discharge of the DC-link capacitor using components normally already present in an electric drive system. A technical benefit may include using the electric machine as an energy dissipator to discharge the DC-link capacitor. Further, when rotating the machine, the current is distributed evenly between stator windings. Therefore, the risk of overheating or unnecessary wear of the components decreases.

Optionally in some examples, including in at least one preferred example, the method further comprises determining, by the processing circuitry, the q current for the electrical machine based on a reference rotational speed of the electrical machine. A technical benefit may include a robust yet efficient control of the electrical machine in order to achieve the desired discharge of the DC-link capacitor.

Optionally in some examples, including in at least one preferred example, the method further comprises setting, by the processing circuitry, the reference rotational speed to a value being higher than the maximum rotational speed being achievable by the electrical energy stored by the DC-link capacitor. A technical benefit may include a fast discharge of the DC-link capacitor.

Optionally in some examples, including in at least one preferred example, the method further comprises setting, by the processing circuitry, the reference rotational speed to a value being less than the maximum rotational speed being achievable by the electrical energy stored by the DC-link capacitor. A technical benefit may include a more controlled discharge of the DC-link capacitor.

Optionally in some examples, including in at least one preferred example, the method further comprises adjusting, by the processing circuitry, the q current for the electrical machine such that the rotational speed of the electrical machine corresponds to the reference rotational speed. A technical benefit may include ensuring a constant speed of the electrical machine during discharging, thereby facilitating control by allowing the q current to be close to zero.

Optionally in some examples, including in at least one preferred example, the method further comprises determining, by the processing circuitry, a d current for the electrical machine being sufficient to discharge the DC-link capacitor to a safe level threshold; and discharging, by the processing circuitry, the DC-link capacitor by applying the determined d current to the electrical machine. A technical benefit may include controlling the discharge time by the d current, as is it possible to change the d current without modifying the torque. Hence, torque may be controlled by modifying the q current, and heat dissipation may be controlled by modifying the d current.

Optionally in some examples, including in at least one preferred example, the method further comprises short circuiting, by the processing circuitry, the electrical machine when the voltage of the DC-link capacitor has reached the safe level threshold. A technical benefit may include reducing the risk for the electrical machine to energize the capacitor.

Optionally in some examples, including in at least one preferred example, the method further comprises disconnecting, by the processing circuitry, an energy storage system of the electric drive system from the electrical machine. A technical benefit may include a simple and easy-to-implement active discharging of the DC-link capacitor.

According to a fourth aspect of the disclosure, a computer program product is provided. The computer program product comprises program code for performing, when executed by the processing circuitry, the method of the third aspect. The fourth aspect of the disclosure may seek to provide a robust discharge of the DC-link capacitor using components normally already present in an electric drive system. A technical benefit may include using the electric machine as an energy dissipator to discharge the DC-link capacitor. Further, when rotating the machine, the current is distributed evenly between stator windings. Therefore, the risk of overheating or unnecessary wear of the components decreases.

According to a fifth aspect of the disclosure, a non-transitory computer-readable storage medium is provided. The non-transitory computer-readable storage medium comprises instructions, which when executed by the processing circuitry, cause the processing circuitry to perform the method of the third aspect. The fifth aspect of the disclosure may seek to may seek to provide a robust discharge of the DC-link capacitor using components normally already present in an electric drive system. A technical benefit may include using the electric machine as an energy dissipator to discharge the DC-link capacitor. Further, when rotating the machine, the current is distributed evenly between stator windings. Therefore, the risk of overheating or unnecessary wear of the components decreases.

There are also disclosed herein computer systems, control units, code modules, computer-implemented methods, computer readable media, and computer program products associated with the above discussed technical benefits.

### BRIEF DESCRIPTION OF THE DRAWINGS

FIG. 1 is an exemplary side view of a vehicle according to an example.

FIG. 2 is an exemplary system diagram of an electrical drive system according to an example.

FIG. 3 is an exemplary system diagram of a discharge control system according to an example.

FIG. 4 is an exemplary system diagram of a discharge control system according to an example.

FIG. 5 is an exemplary system diagram of a discharge control system according to a further example.

FIGS. 6A-B are diagrams showing simulation results of a discharge control system according to an example.

FIGS. 7A-B are diagrams showing simulation results of a discharge control system according to a further example.

FIG. 8 is a flow chart of an exemplary method to discharge a DC-link capacitor according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The examples presented herein provide a solution to the problem of ensuring a safe, robust, and reliable discharge of a DC-link capacitor of an electric drive system.

Operating as a primary discharge system or as a secondary (backup) discharge system, the general idea is to use the energy of the DC-link capacitor to power an electrical machine of the electric drive system, thereby depleting the DC-link capacitor. The electrical machine is controlled to rotate, which thus requires the electrical machine to be disconnected from downstream components of the electric drive system. By having the electrical machine to rotate, the current will be distributed evenly between stator windings thereby reducing the risk for overheating. Further, unnecessary wear of the parts of the electrical machine is decreased.

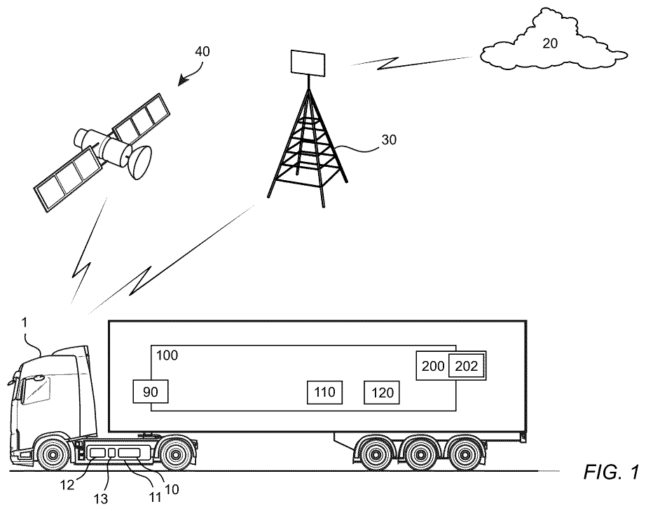

FIG. 1 is an exemplary view of a vehicle 1 according to one example. The vehicle 1 comprises at least one electrical machine 10 used to propel the vehicle 1. The at least one electrical machine 10 forms part of an electric drive system 11 and may be powered by an energy storage system 12, such as one or more batteries, configured to provide electrical energy to the one or more electrical machines 10. The energy storage system 12 may form part of the electric drive system 11, or it may be a separate component being connected to the electric drive system 11.

The electric drive system 11 comprises a DC-link capacitor 13 being configured to balance the load of the energy storage system 12, and to provide a more stable DC voltage by limiting voltage fluctuations.

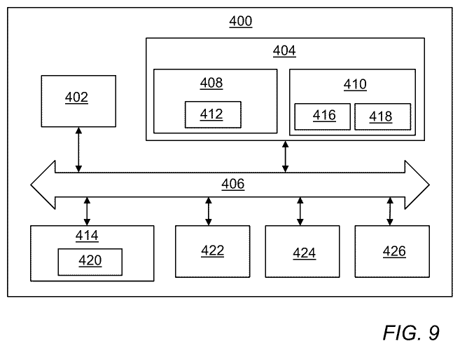

The vehicle 1 comprises, at least to some extent, processing circuitry 110 forming part of a computer system 100 (see FIG. 9). The processing circuitry 110 is configured to implement a discharge control system 200 which is configured to be operatively connected to the electric drive system 11 in order to control discharge of the DC-link capacitor 13.

The vehicle 1 may further comprise communications circuitry 90 configured to receive and/or send communications. The communications circuitry 90 may be configured to enable the vehicle 1 to communicate with one or more external devices or systems such as a cloud server 20. The communication with the external devices or systems may be directly or via a communications interface such as a cellular communications interface 30, such as a radio base station. The cloud server 20 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 90 may, additionally or alternatively, be configured to enable the vehicle 1 to be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 1 may for example be configured to utilize data obtain from the GNSS 40 to determine a geographical location of the vehicle 1.

The vehicle 1 in FIG. 1 comprises the computer system 100 and the discharge control system 200. The computer system 100 may be operatively connected to the discharge control system 200 and optionally to the communications circuitry 90 of the vehicle 1. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100. The discharge control system 200 may comprise discharge control system processing circuitry 202; the discharge control system processing circuitry 202 may be part of the processing circuitry 110 of the computer system 100.

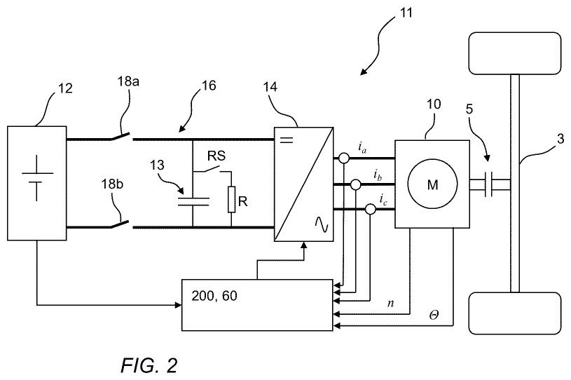

FIG. 2 is a schematic system diagram of an electric drive system 11 according to an example. The electric drive system 11 comprises an electrical machine 10 being configured to provide drive torque to an associated vehicle. In the shown example, the electrical machine 10 is mechanically connected to a drive axle 3 of the associated vehicle by means of a disconnect coupling 5.

A rechargeable energy storage system 12, here in the form of a battery, is configured to provide electrical power to the electrical machine 10. Typically, the battery 12 may have a power of 800V. The battery 12 is connected to a multi-phase inverter 14 via a DC bus 16. The inverter 14 is configured to provide alternating phase currents iₐ, i_{b}, i_{c} to the electrical machine 10.

A DC-link capacitor 13 is arranged on the DC side of the electric drive system 11. The DC-link capacitor 13 may have a resistor R connected in parallel, and connectable by means of a switch RS.

An electrical machine controller 60 is provided and configured to control operation of the electrical machine 10. Preferably, the electrical machine controller 60 is configured to control the electrical machine 10 using field-oriented control. The electrical machine controller 60 is further configured to implement a discharge control system 200. It should be noted that in some examples, the discharge control system 200 forms part of the electrical machine controller 60. In other examples, the discharge control system 200 is implemented by means of a dedicated controller being in operative communication with the electrical machine controller 60.

The electrical machine controller 60 is configured to, based on input parameters such as the phase currents iₐ, i_{b}, i_{c}, the speed n, and the angular position Θ, control the electrical machine 10. Preferably, the discharge control system 200 is configured to use the same, or similar, parameters to control discharge of the DC-link capacitor 13.

Discharge of the DC-link capacitor 13 may be performed when the vehicle 1 is standstill and shut off. The battery 12 is electrically disconnected from the DC bus 16, e.g. by opening contactors 18a, 18b. Following this, the primary control strategy may be to passively discharge the DC-link capacitor 13 by closing the resistor switch RS, thereby allowing the DC-link capacitor 13 to discharge. Optionally, discharge is performed by mechanically disconnecting the electrical machine 10 using the disconnect coupling 5, and then perform active control of the electrical machine 10 by means of the discharge control system 200. Alternatively, active discharging is performed only as a backup if the passive discharging fails.

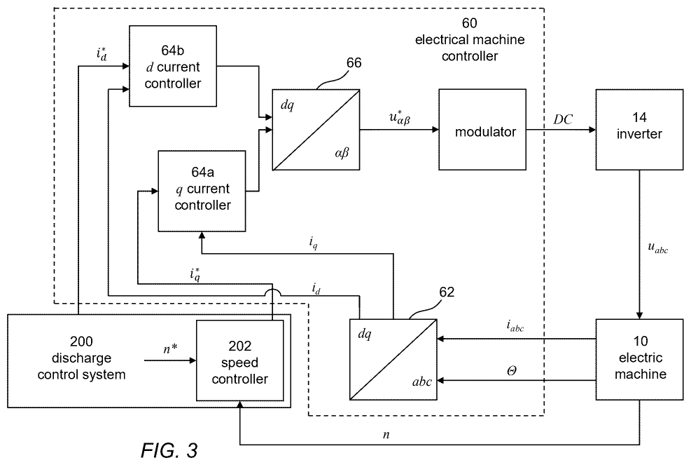

The discharge control system 200 is further described with reference to FIG. 3. In the shown example the discharge control system 200 is shown as an add-on to an electrical machine controller 60, however as previously explained these two controllers/systems may be integrated at any suitable level.

Starting with the electrical machine controller 60, a transformer 62 is configured to receive actual parameters from the electrical machine 10. For field-oriented control, such parameters comprises the phase currents i_{abc} and the angular position Θ. The transformed 62 is configured to transform these parameters to actual dq currents i_{d}, i_{q}. These dq currents i_{d}, i_{q} are used as input for current controllers 64a, 64b together with desired dq currents i_{d}, i_{q}*. During normal operation of the electrical machine 10, the desired or target dq currents i_{d}, i_{q}* may result from a torque request.

An inverse transformer 66 is configured to transform the determined dq currents to desired voltages u_{αβ}*, which are used by a modulator 68 to feed the inverter 14.

For active discharging of the DC-link capacitor 13, the discharge control system 200 comprises a speed controller 202. The speed controller 202 receives the actual speed n of the electrical machine 10, and based on a set target speed n* (being greater than zero) the speed controller outputs the desired dq currents i_{d}*, i_{q}* to the current controllers 64a, 64b. To achieve the rotation of the electrical machine, a small torque is needed to overcome the speed-dependent losses of the electrical machine 10. In addition, the length of the current vector must be free to adjust since it decides the rate of dissipation. To fulfill these prerequisites, the q current is set to control the torque, and therefore also the speed. The q current is preferably limited in magnitude to limit torque generation and subsequently the acceleration of the machine. The d current is preferably set to control the length of the current vector, i.e. the discharge time.

Due to the small amount of energy in the DC-link capacitor 13 it is only possible to accelerate the electrical machine 10 to a relatively low speed. Therefore, there are two options available. One option is to set the speed reference n* to a relatively high (but still safe) value that will not be reached before the energy of the DC-link capacitor 13 is depleted. The other option is to set a lower speed reference n* that will be reached, discharging some energy while the shaft accelerates and the remaining discharging will be performed at a constant speed. When the speed is constant, it is the d current that determines the discharge time since the q current magnitude is negligible.

When the capacitor is discharged to a safe voltage level (e.g. <60V) it is preferred that switches of the inverter 14 short circuit the electrical machine 10 by an Active Short Circuit (ASC) algorithm. Otherwise, the rotating machine 10 may energize the DC-link capacitor 13 again. The ASC algorithm will also generate a high braking torque that will effectively stop the rotation of the electrical machine 10.

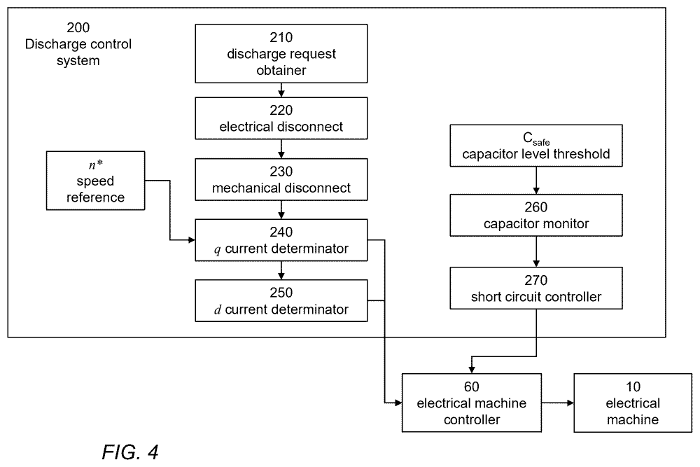

FIG. 4 is an exemplary system diagram of a discharge control system 200 according to an example. The discharge control system 200 comprises a discharge request obtainer 210. The discharge request obtainer 210 is configured to obtain a request for discharge of the DC-link capacitor 13, and to initiate discharging based on such request. The request may be passive, e.g. being automatically obtainer upon shutdown of the vehicle 1. Optionally the request may be obtained due to failure of a primary discharge system.

The discharge control system 200 further comprises an electrical disconnect 220. The electrical disconnect 220 is configured to electrically disconnect the energy storage system 11, e.g. the battery, from the DC bus 16. Such disconnect may e.g. be performed using the contactors 18a, 18b described with reference to FIG. 2.

The discharge control system 200 further comprises a mechanical disconnect 230. The mechanical disconnect 230 is configured to mechanically disconnect the electrical machine 10 from downstream components of the vehicle's drivetrain. The mechanical disconnect may be implemented by means of the disconnect coupling 5 described with reference to FIG. 2.

The discharge control system 200 further comprises a q current determinator 240. The q current determinator 240 is configured to determine a q current for the electrical machine controller 60 such that the electrical machine 10 starts to rotate, thereby drawing electrical energy from the DC-link capacitor 13. Preferably, the q current determinator 240 is configured to receive a speed reference n* and determine the desired q current based on the speed reference n*. As mentioned above, the speed reference n* may be higher than what is possible to obtain based on the available energy of the DC-link capacitor 13, or lower than what is possible to obtain.

The discharge control system 200 further comprises a d current determinator 250. The d current determinator 250 is configured to determine a d current for the electrical machine controller 60 such that the electrical machine 10 continues rotating, thereby drawing electrical energy from the DC-link capacitor 13. In a preferred example, the dq currents are determined such that the q current sets the torque/speed of the electrical machine 10, while the d current sets the duration of the rotation.

The discharge control system 200 further comprises a capacitor monitor 260. The capacitor monitor 260 is preferably a voltage monitor configured to monitor the voltage level, or energy level, of the DC-link capacitor 13. Preferably, the capacitor monitor 260 is configured to receive a capacitor/voltage level threshold C_{safe} that corresponds to a safe level of the capacitor 13. Typically, the capacitor level threshold C_{safe} is around 60V. When the capacitor monitor 260 determines that the actual energy level of the DC-link capacitor 13 has reached the capacitor level threshold C_{safe}, a short circuit controller 270 is activated.

The short circuit controller 270, which preferably is configured to implement an Active Short Circuit (ASC) algorithm, controls the electrical machine 10 (possibly via the electrical machine controller 60 to effectively brake the electrical machine 10.

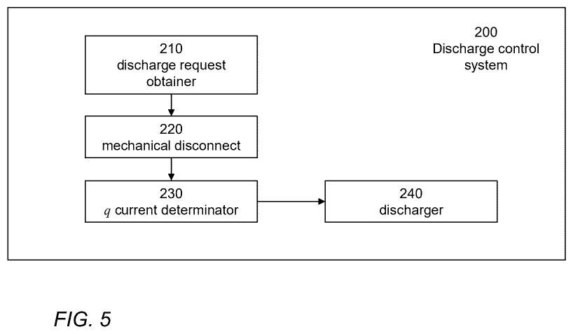

FIG. 5 is an exemplary system diagram of a discharge control system 200 according to an example. The discharge control system 200 comprises a discharge request obtainer 210 configured to obtain a discharge request of a DC-link capacitor 13 of an electric drive system 11. The discharge control system 200 further comprises a mechanical disconnect 220 configured to disconnect an electrical machine 10 of the electric drive system 11, and a q current determinator 230 configured to determine a q current for the electrical machine 10 being sufficient to start rotation of the electrical machine 10. The discharge control system 200 further comprises a discharger 240 being configured to actively discharge the DC-link capacitor 13 by applying the determined q current to the electrical machine 10.

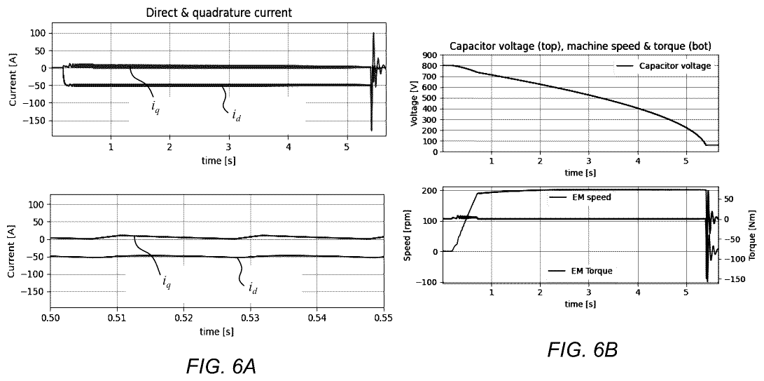

FIGS. 6A-B show simulation results for an active discharge procedure according to an example. The two diagrams of FIG. 6A show the dq currents as a function of time, the bottom diagram being a zoomed in section of the upper diagram. In particular, FIG. 6A shows the dq currents of an active discharge event where the speed reference n* is set to 200 rpms. FIG. 6B shows the results of the DC-capacitor voltage, the torque and speed from the same simulation. The q current is limited to 5 A and the d current is set to a constant of −50 A. The speed reference is set to 200 rpm. When the voltage has reached a safe level of <60V the ASC algorithm is engaged, which creates a braking torque that stops the machine from rotating. The results show that the method performs well and discharges the DC-link capacitor 13 in a controlled manner.

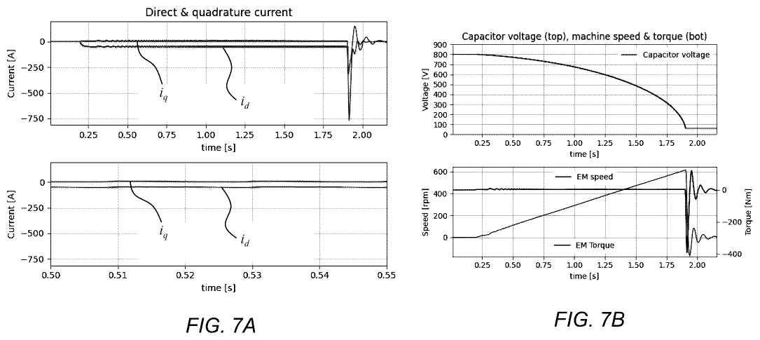

FIGS. 7A-B show simulation results for an active discharge procedure according to another example. The two diagrams of FIG. 7A show the dq currents as a function of time, the bottom diagram being a zoomed in section of the upper diagram. In particular, FIG. 7A shows the dq currents of an active discharge event where the speed reference n* is set much higher than in the example shown in FIGS. 6A-B, in particular to a speed not reachable using the electrical energy available from the DC-link capacitor 13. FIG. 7B shows the results of the DC-capacitor voltage, the torque and speed from the same simulation. When the voltage has reached a safe level of <60V the ASC algorithm is engaged, which creates a braking torque that stops the machine from rotating. The results show that the method performs well and discharges the DC-link capacitor 13 in a controlled manner.

From the simulations shown in FIGS. 6A-B, 7A-B, it is concluded that the method works both when the shaft speed of the electrical machine 10 is in steady state and when it accelerates.

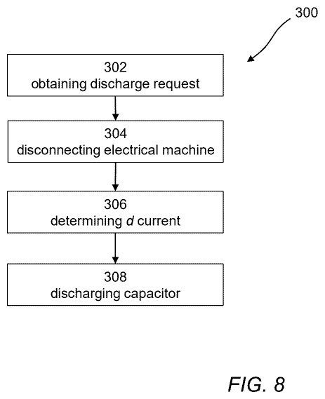

FIG. 8 is a flow chart of an exemplary method 300 to discharge a DC-link capacitor according to an example. The method 300 is preferably a computer-implemented method, comprising obtaining, 302 by processing circuitry of a computer system, a discharge request of a DC-link capacitor 13 of an electric drive system 11. The method 300 further comprises disconnecting 304, by the processing circuitry, an electrical machine 10 of the electric drive system 11, and determining 306, by the processing circuitry, a q current for the electrical machine 10 being sufficient to start rotation of the electrical machine 10. The method 300 further comprises actively discharging 308, by the processing circuitry, the DC-link capacitor 13 by applying the determined q current to the electrical machine 10.

FIG. 9 is a schematic diagram of a computer system 400 for implementing examples disclosed herein. The computer system 400 is adapted to execute instructions from a computer-readable medium to perform these and/or any of the functions or processing described herein. The computer system 400 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 400 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 400 may comprise at least one computing device or electronic device capable of including firmware, hardware, and/or executing software instructions to implement the functionality described herein. The computer system 400 may include processing circuitry 402 (e.g., processing circuitry including one or more processor devices or control units), a memory 404, and a system bus 406. The computer system 400 may include at least one computing device having the processing circuitry 402. The system bus 406 provides an interface for system components including, but not limited to, the memory 404 and the processing circuitry 402. The processing circuitry 402 may include any number of hardware components for conducting data or signal processing or for executing computer code stored in memory 404. The processing circuitry 402 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 402 may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the processing circuitry 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with processing circuitry 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program 420 stored on a transitory or non-transitory computer-usable or computer-readable storage medium (e.g., single medium or multiple media), such as the storage device 414, which includes complex programming instructions (e.g., complex computer-readable program code) to cause the processing circuitry 402 to carry out actions described herein. Thus, the computer-readable program code of the computer program 420 can comprise software instructions for implementing the functionality of the examples described herein when executed by the processing circuitry 402. In some examples, the storage device 414 may be a computer program product (e.g., readable storage medium) storing the computer program 420 thereon, where at least a portion of a computer program 420 may be loadable (e.g., into a processor) for implementing the functionality of the examples described herein when executed by the processing circuitry 402. The processing circuitry 402 may serve as a controller or control system for the computer system 400 that is to implement the functionality described herein.

The computer system 400 may include an input device interface 422 configured to receive input and selections to be communicated to the computer system 400 when executing instructions, such as from a keyboard, mouse, touch-sensitive surface, etc. Such input devices may be connected to the processing circuitry 402 through the input device interface 422 coupled to the system bus 406 but can be connected through other interfaces, such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may include a communications interface 426 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system comprising processing circuitry configured to: obtain a discharge request of a DC-link capacitor (13) of an electric drive system (11); disconnect an electrical machine (10) of the electric drive system (11); determine a q current (i_{q}) for the electrical machine (10) being sufficient to start rotation of the electrical machine (10); and actively discharge the DC-link capacitor (13) by applying the determined q current (i_{q}) to the electrical machine (10).

Example 2: The computer system of Example 1, wherein the processing circuitry is further configured to: determine the q current (i_{q}) for the electrical machine (10) based on a reference rotational speed (n*) of the electrical machine.

Example 3: The computer system of Example 2, wherein the processing circuitry is further configured to: set the reference rotational speed (n*) to a value being higher than the maximum rotational speed being achievable by the electrical energy stored by the DC-link capacitor (13).

Example 4: The computer system of Example 2, wherein the processing circuitry is further configured to: set the reference rotational speed (n*) to a value being less than the maximum rotational speed being achievable by the electrical energy stored by the DC-link capacitor (13).

Example 5: The computer system of Example 4, wherein the processing circuitry is further configured to: adjust the q current (i_{q}) for the electrical machine (10) such that the rotational speed of the electrical machine (10) corresponds to the reference rotational speed (n*).

Example 6: The computer system of any of Examples 1-5, wherein the processing circuitry is further configured to: determine a d current (i_{d}) for the electrical machine (10) being sufficient to discharge the DC-link capacitor to a safe level threshold (C_{safe}); and discharge the DC-link capacitor (13) by applying the determined d current (i_{d}) to the electrical machine (10).

Example 7: The computer system of Example 6, wherein the processing circuitry is further configured to: short circuit the electrical machine (10) when the voltage of the DC-link capacitor (13) has reached the safe level threshold (C_{safe}).

Example 8: The computer system of Example 1, wherein the processing circuitry is further configured to: disconnect an energy storage system (12) of the electric drive system (11) from the electrical machine (10); determine the q current (i_{q}) for the electrical machine (10) based on a reference rotational speed (n*) of the electrical machine; set the reference rotational speed (n*) to a value being higher than the maximum rotational speed being achievable by the electrical energy stored by the DC-link capacitor (13), or set the reference rotational speed (n*) to a value being less than the maximum rotational speed being achievable by the electrical energy stored by the DC-link capacitor (13), and adjust the q current (i_{q}) for the electrical machine (10) such that the rotational speed of the electrical machine (10) corresponds to the reference rotational speed (n*); wherein the processing circuitry is further configured to: determine a d current (i_{d}) for the electrical machine (10) being sufficient to discharge the DC-link capacitor to a safe level threshold (C_{safe}); and discharge the DC-link capacitor (13) by applying the determined d current (i_{d}) to the electrical machine (10); wherein the processing circuitry is further configured to: short circuit the electrical machine (10) when the voltage of the DC-link capacitor (13) has reached the safe level threshold (C_{safe}).

Example 9: A vehicle (1) comprising the computer system of any of Examples 1-8.

Example 10: The vehicle of Example 9, further comprising: an electric drive system (11), and a DC-link discharge system (R, RS) configured to passively discharge the DC-link capacitor (13).

Example 11: A computer-implemented method, comprising: obtaining, by processing circuitry of a computer system, a discharge request of a DC-link capacitor (13) of an electric drive system (11); disconnecting, by the processing circuitry, an electrical machine (10) of the electric drive system (11); determining, by the processing circuitry, a q current (i_{q}) for the electrical machine (10) being sufficient to start rotation of the electrical machine (10); and actively discharging, by the processing circuitry, the DC-link capacitor (13) by applying the determined q current (i_{q}) to the electrical machine (10).

Example 12: The method of Example 11, further comprising: determining, by the processing circuitry, the q current (i_{q}) for the electrical machine (10) based on a reference rotational speed (n*) of the electrical machine.

Example 13: The method of Example 12, further comprising: setting, by the processing circuitry, the reference rotational speed (n*) to a value being higher than the maximum rotational speed being achievable by the electrical energy stored by the DC-link capacitor (13).

Example 14: The method of Example 12, further comprising: setting, by the processing circuitry, the reference rotational speed (n*) to a value being less than the maximum rotational speed being achievable by the electrical energy stored by the DC-link capacitor (13).

Example 15: The method of Example 14, further comprising: adjusting, by the processing circuitry, the q current (i_{q}) for the electrical machine (10) such that the rotational speed of the electrical machine (10) corresponds to the reference rotational speed (n*).

Example 16: The method of any of Examples 11-15, further comprising: determining, by the processing circuitry, a d current (i_{d}) for the electrical machine (10) being sufficient to discharge the DC-link capacitor to a safe level threshold (C_{safe}); and discharging, by the processing circuitry, the DC-link capacitor (13) by applying the determined d current (i_{d}) to the electrical machine (10).

Example 17: The method of Example 16, further comprising: short circuiting, by the processing circuitry, the electrical machine (10) when the voltage of the DC-link capacitor (13) has reached the safe level threshold (C_{safe}).

Example 18: The method of any of Examples 11-17, further comprising: disconnecting, by the processing circuitry, an energy storage system (12) of the electric drive system (11) from the electrical machine (10).

Example 19: A computer program product comprising program code for performing, when executed by the processing circuitry, the method of any of Examples 11-18.

Example 20: A non-transitory computer-readable storage medium comprising instructions, which when executed by the processing circuitry, cause the processing circuitry to perform the method of any of Examples 11-18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain a discharge request of a DC-link capacitor of an electric drive system;
disconnect an electrical machine of the electric drive system;
determine a q current for the electrical machine being sufficient to start rotation of the electrical machine; and
actively discharge the DC-link capacitor by applying the determined q current to the electrical machine.

2. The computer system of claim 1, wherein the processing circuitry is further configured to:
determine the q current for the electrical machine based on a reference rotational speed of the electrical machine.

3. The computer system of claim 2, wherein the processing circuitry is further configured to:
set the reference rotational speed to a value being higher than the maximum rotational speed being achievable by the electrical energy stored by the DC-link capacitor.

4. The computer system of claim 2, wherein the processing circuitry is further configured to:
set the reference rotational speed to a value being less than the maximum rotational speed being achievable by the electrical energy stored by the DC-link capacitor.

5. The computer system of claim 4, wherein the processing circuitry is further configured to:
adjust the q current for the electrical machine such that the rotational speed of the electrical machine corresponds to the reference rotational speed.

6. The computer system of claim 1, wherein the processing circuitry is further configured to:
determine a d current for the electrical machine being sufficient to discharge the DC-link capacitor to a safe level threshold; and
discharge the DC-link capacitor by applying the determined d current to the electrical machine.

7. The computer system of claim 6, wherein the processing circuitry is further configured to:
short circuit the electrical machine when the voltage of the DC-link capacitor has reached the safe level threshold.

8. The computer system of claim 1, wherein the processing circuitry is further configured to:
disconnect an energy storage system of the electric drive system from the electrical machine;
determine the q current for the electrical machine based on a reference rotational speed of the electrical machine;
set the reference rotational speed to a value being higher than the maximum rotational speed being achievable by the electrical energy stored by the DC-link capacitor, or
set the reference rotational speed to a value being less than the maximum rotational speed being achievable by the electrical energy stored by the DC-link capacitor, and adjust the q current for the electrical machine such that the rotational speed of the electrical machine corresponds to the reference rotational speed;
wherein the processing circuitry is further configured to:
determine a d current for the electrical machine being sufficient to discharge the DC-link capacitor to a safe level threshold; and
discharge the DC-link capacitor by applying the determined d current to the electrical machine;
wherein the processing circuitry is further configured to:
short circuit the electrical machine when the voltage of the DC-link capacitor has reached the safe level threshold.

9. A vehicle comprising the computer system of claim 1.

10. The vehicle of claim 9, further comprising:
an electric drive system, and
a DC-link discharge system configured to passively discharge the DC-link capacitor.

11. A computer-implemented method, comprising:
obtaining, by processing circuitry of a computer system, a discharge request of a DC-link capacitor of an electric drive system;
disconnecting, by the processing circuitry, an electrical machine of the electric drive system;
determining, by the processing circuitry, a q current for the electrical machine being sufficient to start rotation of the electrical machine; and
actively discharging, by the processing circuitry, the DC-link capacitor by applying the determined q current to the electrical machine.

12. The method of claim 11, further comprising:
determining, by the processing circuitry, the q current for the electrical machine based on a reference rotational speed of the electrical machine.

13. The method of claim 11, further comprising:
short circuiting, by the processing circuitry, the electrical machine when the voltage of the DC-link capacitor has reached a safe level threshold.

14. A computer program product comprising program code for performing, when executed by the processing circuitry, the method of claim 11.

15. A non-transitory computer-readable storage medium comprising instructions, which when executed by the processing circuitry, cause the processing circuitry to perform the method of claim 11.
